(19) United States
(12) Patent Application Publication
(10) Pub. No.: US 2020/0096353 A1
(43) Pub. Date: Mar. 26, 2020

(54) INFORMATION PROCESSING DEVICE, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Masahiro MISAKI, Nagoya-shi (JP); Orie MITSUHASHI, Kasugai-shi (JP); Masahiro UEDA, Nisshin-shi (JP); Yoshitaka ATSUMI, Toyota-shi (JP); Naoto SASAGAWA, Nishio-shi (JP); Naoki YAMAMURO, Nagoya-shi (JP); Chiho OGAWA, Toyota-shi (JP)

(73) Assignee: TOYOTA JIDOSHA KABUSHIKI KAISHA, Toyota-shi (JP)

(21) Appl. No.: 16/578,775

(22) Filed: Sep. 23, 2019

(30) Foreign Application Priority Data
Sep. 21, 2018 (JP) 2018-177448

(51) Int. Cl. G01C 21/34; G06Q 30/06

(52) U.S. Cl. CPC G01C 21/3476; G06Q 30/0633

(57) ABSTRACT

The present disclosure provides a technique capable of assisting a user in purchasing goods desired to be purchased. In the information processing device, a travel route on which the user is able to purchase as many goods as possible included in the shopping list information by dropping in at each of the sales stores located on the travel route of the vehicle while the vehicle is moving toward the destination, is generated as a guidance route. Then, the store information regarding each sales store located on the guidance route is provided to the user together with the guidance route.

### CROSS REFERENCE TO THE RELATED APPLICATION

This application claims the benefit of Japanese Patent Application No. 2018-177448, filed on Sep. 21, 2018, which is hereby incorporated by reference herein in its entirety.

### BACKGROUND

### Technical Field

The present disclosure relates to an information processing device, an information processing method, and a non-transitory storage medium.

### Description of the Related Art

In recent years, a technique for supporting the purchase of goods or commodities by a user has been developed. For example, Patent Document 1 discloses a technique of generating a route for shopping and transmitting it to a user terminal. According to the art disclosed in Patent Document 1, the purchase condition including the kind, quantity, and amount of each item of the goods that the user desires to purchase is acquired. Further, the advertisement information is acquired from a plurality of stores. Further, based on the acquired purchase condition and the advertisement information, a purchase schedule list including a store selling the goods which the user desires to purchase and an amount of money of the goods is generated, and the purchase schedule list is transmitted to the user terminal. Then, a purchase response to the purchase schedule list is received from the user terminal, and a shopping route is generated based on the purchase response.

Patent Document 2 discloses a technique of notifying a user terminal of store information relating to a store that exists within a fixed distance from a user terminal (mobile terminal) possessed by the user and that is selling the goods which the user desires to purchase.

Patent Document 3 discloses a technique related to a support device for ordering the goods which a user desires to purchase to a plurality of stores. Patent Document 3 discloses that a store where the price for each of the goods which the user desires to purchase is the lowest is selected as a destination of ordering. Further, Patent Document 3 discloses that the same stores are selected as much as possible as ordering destinations, so that when the user goes around a plurality of stores to which the user has placed orders for the goods, the number of stores to go around becomes a minimum.

### CITATION LIST

### Patent Document

[Patent document 1] Japanese Patent Laid-Open No. 2009-128935

[Patent document 2] Japanese Patent Laid-Open No. 2002-175465

[Patent document 3] Japanese Patent Laid-Open No. 2018-63660

### SUMMARY

An object of the present disclosure is to provide a technique capable of assisting a user to purchase goods which the user desires to purchase while moving toward a destination by a vehicle.

An information processing device according to the first embodiment of the present disclosure is an information processing device for generating a guidance route which is a travel route from a current position of a vehicle in which a user is riding to a destination of the vehicle, and providing the generated guidance route to the user, wherein the information processing device may include a controller comprising at least one processor configured to execute:

acquiring shopping list information, which is information on a list of goods that the user riding in the vehicle desires to purchase,

acquiring store information which is information relating to each of a plurality of sales stores existing in a predetermined area in which the guidance route can be generated and selling at least a part of the goods included in the shopping list information, the store information including information about the goods included in the shopping list information and being sold at each of the sales store,

generating, as the guidance route, on the basis of the shopping list information and the store information relating to each of the plurality of sales stores, a travel route on which the user is able to purchase as many goods as possible included in the shopping list information by dropping in at each of the sales stores located on the travel route of the vehicle while the vehicle is moving toward the destination, and

providing the user with the store information about each of the sale stores located on the guidance route, with the guidance route.

An information processing method according to the second embodiment of the present disclosure is an information processing method for generating a guidance route which is a travel route from a current position of a vehicle in which a user is riding to a destination of the vehicle, and providing the generated guidance route to the user, by a computer, wherein the information processing method may include;

a step of acquiring shopping list information, which is information on a list of goods that the user riding in the vehicle desires to purchase,

a step of acquiring store information which is information relating to each of a plurality of sales stores existing in a predetermined area in which the guidance route can be generated and selling at least a part of the goods included in the shopping list information, the store information including information about the goods included in the shopping list information and being sold at each of the sales store,

a step of generating, as the guidance route, on the basis of the shopping list information and the store information relating to each of the plurality of sales stores, a travel route on which the user is able to purchase as many goods as possible included in the shopping list information by dropping in at each of the sales stores located on the travel route of the vehicle while the vehicle is moving toward the destination, and

a step of providing the user with the store information about each of the sale stores located on the guidance route, with the guidance route.

A non-transitory storage medium according to the third embodiment of the present disclosure is a non-transitory storage medium storing a program being configured to cause a computer to generate a guidance route which is a travel route from a current position of a vehicle in which a user is riding to a destination of the vehicle, and provide the generated guidance route to the user, wherein the program may be configured to cause the computer to execute;

a step of acquiring shopping list information, which is information on a list of goods that the user riding in the vehicle desires to purchase,

a step of acquiring store information which is information relating to each of a plurality of sales stores existing in a predetermined area in which the guidance route can be generated and selling at least a part of the goods included in the shopping list information, the store information including information about the goods included in the shopping list information and being sold at each of the sales store,

a step of generating, as the guidance route, on the basis of the shopping list information and the store information relating to each of the plurality of sales stores, a travel route on which the user is able to purchase as many goods as possible included in the shopping list information by dropping in at each of the sales stores located on the travel route of the vehicle while the vehicle is moving toward the destination, and

a step of providing the user with the store information about each of the sale stores located on the guidance route, with the guidance route.

According to the present disclosure, it is possible to assist a user to purchase which the user desires to purchase while moving toward a destination by a vehicle.

### BRIEF DESCRIPTION OF THE DRAWINGS

FIG. 1 is a diagram illustrating a schematic configuration of a shopping support system according to an embodiment.

FIG. 2 is a block diagram schematically illustrating a functional configuration of each of an in-vehicle device, a user terminal, a management server, and a store server constituting the shopping support system.

FIG. 3 is a first diagram illustrating a table structure of shopping list information stored in the shopping list information database.

FIG. 4 is a first diagram illustrating a table structure of store information stored in the store information database.

FIG. 5 is a first diagram illustrating a predetermined area W in which a guidance route of a vehicle can be generated, and stores existing in the predetermined area W.

FIG. 6 is a first diagram for explaining travel routes of the vehicle that can be generated within a predetermined area W.

FIG. 7 is a first diagram for explaining a guidance route of the vehicle displayed on a display device of the in-vehicle device, and store information regarding each sales store located on the guidance route.

FIG. 8 is a flowchart illustrating the flow of the guidance route generation processing.

FIG. 9 is a second diagram illustrating a table structure of shopping list information stored in the shopping list information database.

FIG. 10 is a second diagram for explaining a guidance route of the vehicle displayed on a display device of the in-vehicle device and store information relating to each sales store located on the guidance route.

FIG. 11 is a second diagram illustrating a predetermined area W in which a guidance route of a vehicle can be generated, and stores existing in the predetermined area W.

FIG. 12 is a second diagram illustrating a table structure of store information stored in the store information database.

FIG. 13 is a second diagram for explaining a travel route of the vehicle that can be generated within a predetermined area W.

FIG. 14 is a third diagram for explaining a guidance route of the vehicle displayed on a display device of the in-vehicle device and store information relating to each sales store located on the guidance route.

FIG. 15 is a fourth diagram for explaining a guidance route of the vehicle displayed on a display device of the in-vehicle device and store information relating to each sales store located on the guidance route.

### DESCRIPTION OF THE EMBODIMENTS

In the information processing device according to the first embodiment of the present disclosure, the controller may generate a guidance route which is a travel route from the current position of the vehicle in which the user is riding to the destination of the vehicle. The controller may provide the generated guidance route to the user. At this time, the controller may provide the guidance route to the user as an image and/or sound.

Then, the controller may acquire shopping list information which is information related to a list of goods that the user riding in the vehicle desires to purchase. At this time, the controller may receive the shopping list information from, for example, a user terminal possessed by the user. In this case, goods which the user desires to purchase may be input to the user terminal by an input operation of the user. Then, in the user terminal, shopping list information may be generated based on the input of the user, and the generated shopping list information may be transmitted from the user terminal to the information processing device.

Further, the controller may acquire store information regarding each of a plurality of sales stores existing in a predetermined area. Here, the predetermined area is an area in a range in which the guidance route of the vehicle in which the user is riding can be generated. The predetermined area may be defined based on the current position and the destination of the vehicle. The sales store is a store that sells at least a part of the goods included in the shopping list information. The store information acquired by the controller includes information on the goods included in the shopping list information and sold at each sales store.

Then, based on the shopping list information and the store information relating to each of the plurality of sales stores, the controller may generate a travel route passing through a part of the plurality of sales stores as a guidance route. Since there are the plurality of sale stores, a plurality of travel routes can be generated through different sales stores. Therefore, the controller may generate, as the guidance route, a travel route on which the user is able to purchase as many goods as possible included in the shopping list information by dropping in at each of the sales stores located on the travel route of the vehicle while the vehicle is moving toward the destination.

Then, the controller may provide the user with the shop information about each sales store located on the generated guidance route. Here, the store information provided to the user may include information for the user to identify the sales store (e.g., location information and the name of the store) and information about the goods included in the shopping list information and sold at the sales store.

According to the information processing device described above, when the vehicle travels on the generated guidance route and the vehicle is moving toward the destination, it is possible for the user to purchase the goods which the user desires to purchase by dropping in at each of the sales stores located on the travel route. Further, according to the information processing device described above, a travel route is generated as a guidance route that allows the user to purchase as many goods as possible included in the shopping list information. Therefore, it is possible for the user to purchase as many goods as possible while the vehicle is moving toward the destination. In addition, by providing the user with the store information regarding each sales store located on the guidance route, the user can be prompted to drop in at each sales store while traveling toward the destination. That is, it is possible to prompt the user to purchase the good which the user desires to purchase while the vehicle is moving toward the destination.

Hereinafter, specific embodiments of the present disclosure will be described with reference to drawings. Dimensions, materials, shapes, relative positions and the like of structural components described in the present embodiments are not intended to limit the technical scope of the disclosure unless specified otherwise.

### First Embodiment

(Outline of System)

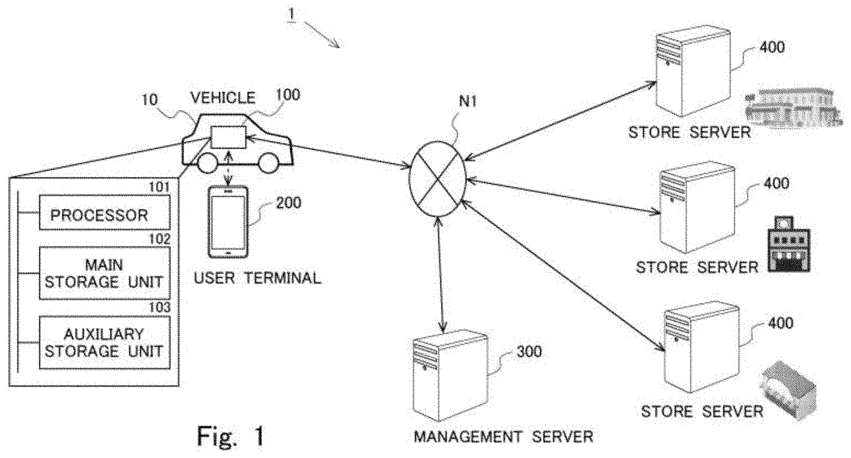

FIG. 1 is a diagram illustrating a schematic configuration of a shopping support system according to the present embodiment. The shopping support system 1 includes an in-vehicle device 100 mounted on a vehicle 10 on which a user is ridding, a user terminal 200 possessed by the user, a management server 300, and store servers 400 provided in each store.

In the shopping support system 1, the in-vehicle device 100, the management server 300, and the store servers 400 are connected to each other via a network N1. As the network N1, for example, a WAN (Wide Area Network) which is a world-wide public communication network such as the Internet, or a telephone communication network such as a mobile telephone may be adopted. The in-vehicle device 100 and the user terminal 200 are connected to each other by short distance wireless communication. The communication between the in-vehicle device 100 and the user terminal 200 is not necessarily performed by short distance wireless communication, and may be performed via the network N1, for example.

The in-vehicle device 100 includes a general computer. The computer constituting the in-vehicle device 100 includes a processor 101 such as a CPU or a DSP, a main storage unit 102 such as a read-only memory (ROM) or a random access memory (RAM), and an auxiliary storage unit 103 such as a EPROM, a hard disk drive (HDD), or a removable medium. Here, the removable medium is a flash memory such as a USB memory or an SD card, or a disk recording medium such as a CD-ROM, a DVD disk or a Blu-ray disc.

An operating system (OS), various programs, various information tables and the like are stored in the auxiliary storage unit 103 of the in-vehicle device 100. In the in-vehicle device 100, the processor 101 loads a program stored in the auxiliary storage unit 103 into the main storage unit 102 and executes the program, whereby various functions, which will be described later, can be implemented. However, some or all of the functions of the in-vehicle device 100 may be implemented by hardware circuits such as an ASIC and a FPGA. Additionally, the in-vehicle device 100 does not necessarily have to be achieved by a single physical configuration and may be formed by a plurality of computers operating in coordination.

The in-vehicle device 100 generates a guidance route which is a travel route from the current position of the vehicle 10 to the destination. At this time, the in-vehicle device 100 generates, as the guidance route, a travel route on which the user can purchase goods which the user desires to purchase until the vehicle 10 arrives at the destination. Specifically, the in-vehicle device 100 receives shopping list information from the user terminal 200 of the user riding in the vehicle 10 by short distance wireless communication. The shopping list information is information relating to a list of goods which the user desires to purchase.

The user terminal 200 includes a computer including a processor, a main storage unit, and an auxiliary storage unit. As the user terminal 200, a smartphone, a tablet computer, a mobile computer, a wearable computer, a wireless storage, a mobile phone, a hand-held terminal or the like may be cited. A predetermined application for using the shopping support system 1 is installed in the user terminal 200. The user can register the shopping list information in the user terminal 200 by operating the predetermined application in the user terminal 200.

Further, the in-vehicle device 100 receives, from the management server 300, store information relating to a plurality of stores existing in a predetermined area where the guidance route can be generated and selling at least a part of the goods included in the shopping list information. The store information to be received includes information about the goods included in the shopping list information that are sold at each of the sales store.

The management server 300 and each store server 400 include a computer having a processor, a main storage unit, and an auxiliary storage unit. The management server 300 is a server for managing store information relating to each store. The store information includes sales goods information which is information on goods (sales goods) sold at each store. The store server 400 is a server for managing sales goods information relating to each store. To the management server 300, sales goods information is transmitted from the store server 400 of each store. Then, the management server 300 manages the store information regarding each store including the sales goods information received from each store server 400. In addition, the management server 300 transmits, to the in-vehicle device 100, store information relating to each sales store and including information about the goods included in the shopping list information.

The in-vehicle device 100 generates a guidance route on the basis of the shopping list information received from the user terminal 200 and the store information regarding each sales store received from the management server 300, in addition to the current position information and the destination information of the vehicle 10. At this time, the in-vehicle device 100 generates, as the guidance route, a travel route on which the user is able to purchase as many goods as possible included in the shopping list information by dropping in at each of the sales stores located on the travel route of the vehicle while the vehicle is moving toward the destination. Further, the in-vehicle device 100 displays, on a display device installed in the vehicle 10, store information relating to each sales store located on the guidance route, with the guidance route. As a result, the guidance route and the store information about each sales store located on the guidance route are provided to the user.

(System Configuration)

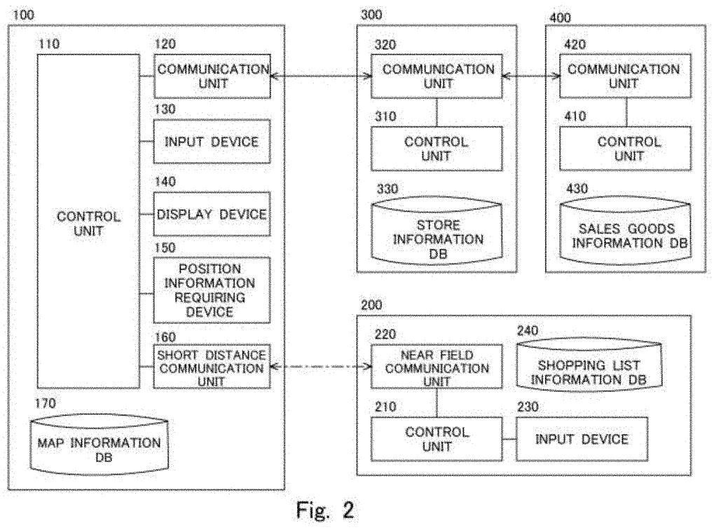

Next, the functional configurations of the in-vehicle device 100, the user terminal 200, the management server 300, and the store server 400 that constitute the shopping support system 1 according to the present embodiment will be described with reference to FIG. 2. FIG. 2 is a block diagram schematically illustrating an example of the functional configuration of each of the in-vehicle device 100, the user terminal 200, the management server 300, and the store server 400 that constitute the shopping support system 1 according to the present embodiment.

(In-Vehicle Apparatus)

The in-vehicle device 100 includes a control unit 110, a communication unit 120, an input device 130, a display device 140, a position information acquiring unit 150, a short distance communication unit 160, and a map information database (map information DB) 170. Furthermore, the control unit 110 includes a function of performing arithmetic processing for controlling the in-vehicle device 100. The control unit 110 may be implemented by the processor 101. Furthermore, various processes by the control unit 110 may be implemented by the processor 101 loading programs stored in the auxiliary storage unit into the main storage unit and executing the programs. For example, the control unit 110 executes guidance route generation processing for generating a guidance route to be guided to the user as a travel route from the current position of the vehicle 10 to the destination. Details of the guidance route generation processing will be described later.

The communication unit 120 is a communication device for connecting the in-vehicle device 100 to the network N1. The communication unit 120 can communicate with other devices including the management server 300 via the network N1 using mobile communication services such as 3G (3rd Generation) or LTE (Long Term Evolution), for example. The control unit 110 executes processing for transmitting the shopping list information received from the user terminal 200 to the management server 300 via the communication unit 120. In addition, the control unit 110 executes processing for receiving store information regarding each sales store from the management server 300 via the communication unit 120.

The input device 130 is a device in which an input operation is performed by a user. The user can input the destination information of the vehicle 10 by operating the input device 130. The control unit 110 acquires the destination information input via the input device 130. As described above, the display device 140 is a device that displays the guidance route of the vehicle 10 generated by the control unit 110 and store information relating to each sales store located on the guidance route. The control unit 110 executes processing for displaying the guidance route and the store information on the display device 140. The input device 130 and the display device 140 may be configured by a single touch panel display.

The position information acquiring unit 150 is a device for acquiring current position information of the vehicle 10 on which the in-vehicle device 100 is mounted. Typically, the position information acquiring unit 150 is a GPS (Global Positioning System) device. The control unit 110 executes a process for acquiring the current position information of the vehicle 10 via the position information acquiring unit 150.

The short distance communication unit 160 is a device that performs communication with the user terminal 200 existing in a relatively short distance range from the vehicle 10 by using a predetermined wireless communication standard. Examples of the communication standard that can be used for communication by the short distance communication unit 160 include Bluetooth (registered trademark) Low Energy standard, NFC (Near Field Communication), UWB (Ultra Wideband), WiFi (registered trademark), and the like. The control unit 110 executes processing for receiving shopping list information from the user terminal 200 via the short distance communication unit 160.

The map information DB 170 is constructed in the auxiliary storage unit 103. The map information DB 170 stores map information used when the control unit 110 generates a guidance route.

(User Terminal)

The user terminal 200 includes a control unit 210, a short distance communication unit 220, an input device 230, and a shopping list information database (shopping list information DB) 240. The control unit 210 includes a function of performing arithmetic processing for controlling the user terminal 200. The control unit 210 may be implemented by the processor. Furthermore, various processes by the control unit 210 may be implemented by the processor loading programs stored in the auxiliary storage unit into the main storage unit and executing the programs.

The short distance communication unit 220 is a device that performs communication with the in-vehicle device 100 according to the same communication standard as that of the short distance communication unit 160 of the in-vehicle device 100. The input device 230 is a device that enables a user to perform an input operation by operating the predetermined application in the user terminal 200. The user can register the shopping list information in the user terminal 200 by operating the input device 230 to input the goods he/she wants to purchase. As the input device 230, a touch panel display can be exemplified.

The control unit 210 generates shopping list information based on the user's operation of the inputting device 230 and stores the generated shopping list information in the shopping list information DB 240. The shopping list information DB 240 is constructed in the auxiliary storage unit of the user terminal 200 by the processor of the user terminal 200 executing programs of the database managing system (Database Management System).

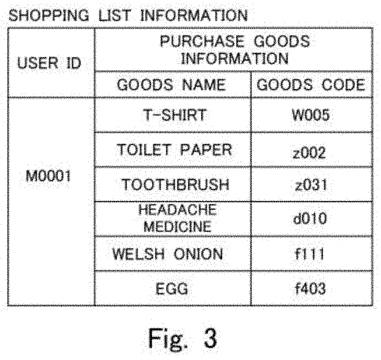

FIG. 3 is a diagram illustrating an exemplary table configuration of shopping list information stored in the shopping list information DB 240. As shown in FIG. 3, the shopping list information table has a user ID field and purchase goods information field. In the user ID field, a user ID, which is identification information for specifying a user, is input. In the purchase goods information field, goods name (item) of goods (purchase goods) which the user desires to purchase, which is input by the user, and goods code set in advance for each good are input. In the examples shown in FIG. 3, a total of six items of “T-shirt,” “toilet paper,” “toothbrush,” “headache medicine,” “welsh onion,” and “eggs” are registered as purchase goods of the user (user ID: M0001). Then, the control unit 210 transmits the shopping list information stored in the shopping list information DB 240 to the in-vehicle device 100 via the short distance communication unit 220.

(Management Server, Store Server)

The management server 300 includes a control unit 310, a communication unit 320, and a store information database (store information DB)330. The store server 400 includes a control unit 410, a communication unit 420, and a sales goods information database (sales goods information DB) 430. Each of the control units 310 and 410 has a function of performing arithmetic processing for controlling each of the servers 300 and 400. Each of the control units 310 and 410 can be realized by a processor of each of the servers 300 and 400. In each of the servers 300 and 400, various processes by the respective control units 310 and 410 may be implemented by the processor loading programs stored in the auxiliary storage unit into the main storage unit and executing the programs.

Each of the communication units 320 and 420 is a communication device for connecting each of the servers 300 and 400 to the network N1. Each of the communication units 320 and 420 includes, for example, LAN (Local Area Network) interface boards and wireless communication circuits for wireless communication.

In the store server 400, the sales goods information of the store in which the store server 400 is installed is stored in the sales goods information DB 430. The sales goods information includes the goods name (item) and price information of each sales goods, coupon information on the store, and the like. Here, the coupon information is information indicating a content of service such as a price discount that the user can receive by presenting the coupon information when the user purchases the target goods. The sales goods information stored in the sales goods information DB 430 is appropriately updated in accordance with the sales status of the respective goods in the store.

Then, in the store server 400, the control unit 410 executes processing for transmitting the sales good information stored in the sales goods information DB 430 to the managing server 300 via the communication unit 420. In the management server 300, the control unit 310 executes processing for receiving the sales goods information transmitted from each store server 400 via the communication unit 320. Further, in the management server 300, the control unit 310 executes processing for storing the sales goods information on each store received from each store server 400 in the store information DB. The store information DB 330 is constructed in the auxiliary storage unit of the management server 300 by the processor of the management server 300 executing programs of the database management system (Database Management System).

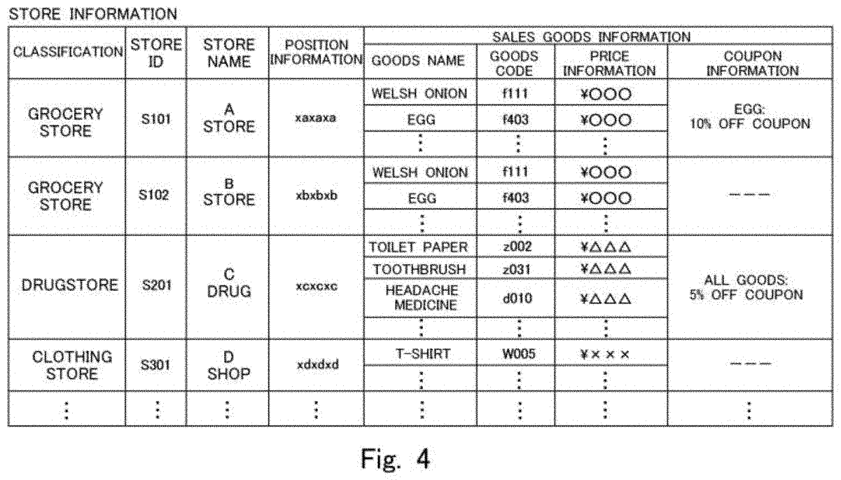

FIG. 4 is a diagram illustrating an exemplary table configuration of store information stored in the store information DB 330. As shown in FIG. 4, the store information table has a classification field, a store ID field, a store name field, a location information field, and a sales goods information field. In the classification field, the class (category) of the store is input. In the store ID field, a store ID, which is identification information for specifying a store, is input. In the store name field, the name of the store is input. In the location information field, location information of a store, for example, an address, is input. In the sales goods information field, the sales goods information received from each store server 400 is input. The sales goods information includes goods name (item), goods code (code determined in advance for each good), and price information, on each sales good, and coupon information on the store.

Then, in the management server 300, the control unit 310 executes processing for extracting, from the store information DB 330, store information relating to each sales store existing in a predetermined area where the guidance route for the vehicle 10 can be generated, and transmitting the store information relating to each extracted sales store to the in-vehicle device 100 via the communication unit 320.

(Guide Route Generation Process)

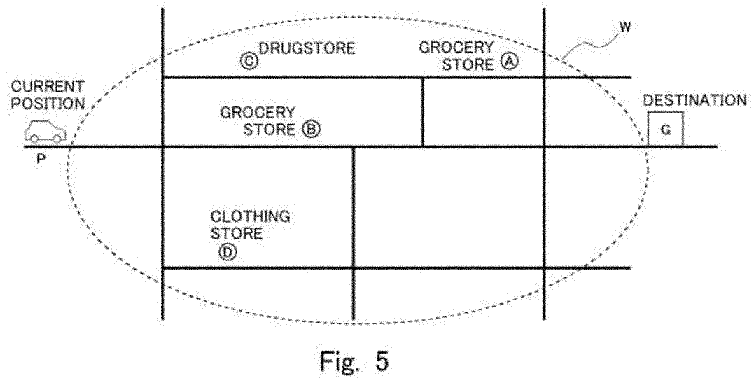

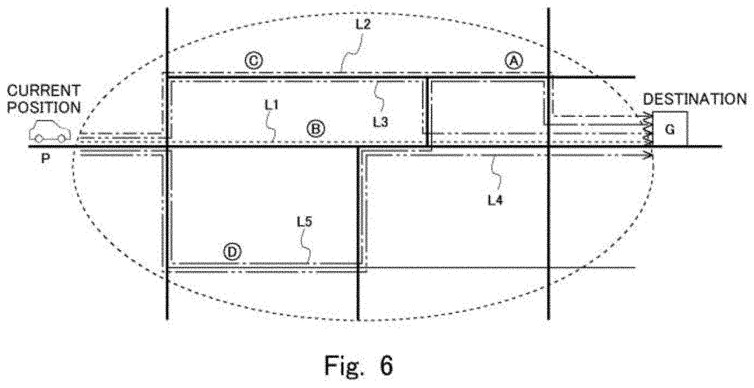

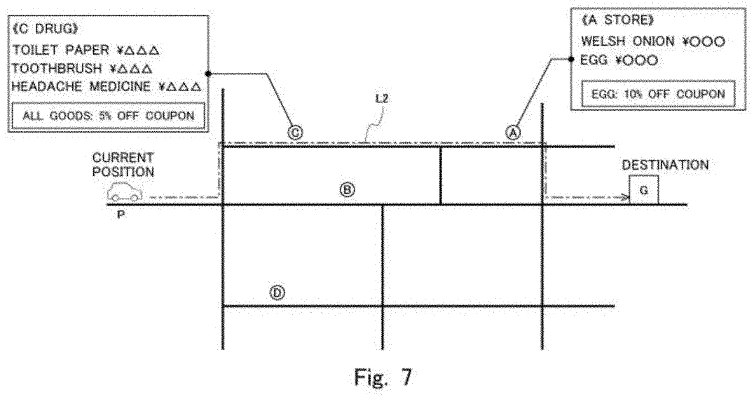

Next, an example of the guidance route generation process executed by the control unit 110 of the in-vehicle device 100 will be described with reference to FIGS. 5 to 7. FIG. 5 is a diagram illustrating a predetermined area W in which the guidance route of the vehicle 10 can be generated, and stores existing in the predetermined area W. FIG. 6 is a diagram for explaining five travel routes of the vehicle 10 that can be generated within the predetermined area W. FIG. 7 is a diagram for explaining a guidance route of the vehicle 10 and store information relating to each sales store located on the guidance route, which is displayed on the display device 140 of the in-vehicle device 100 as a result of execution of the guidance route generation process. Here, the processing executed on the assumption that the in-vehicle device 100 has received the shopping list information shown in FIG. 3 will be described as an example.

FIG. 5 shows map information including the current position P and the destination G of the vehicle 10. In FIG. 5, an area surrounded by a broken line, which exists between the current position P and the destination G of the vehicle 10, indicates a predetermined area W in which the guidance route of the vehicle 10 can be generated. The predetermined area W is an area defined by the current position P and the destination G of the vehicle 10. Here, as shown in FIG. 5, four stores A to D exist in a predetermined area W. These stores A to D correspond to “A store”, “B store”, “C drag” and “D shop” included in the store information table shown in FIG. 4, respectively. That is, the store information included in the store information table shown in FIG. 4 indicates the store information relating to the stores A to D shown in FIG. 5.

In the guidance route generation processing according to the present embodiment, the travel route connecting the current position P of the vehicle 10 to the destination G is not simply generated as the guidance route, but a travel route on which the user is able to purchase the purchase goods while the vehicle 10 is moving toward the destination G is generated as the guidance route. Therefore, the control unit 110 acquires store information regarding a plurality of stores existing in the predetermined area W and selling at least a part of the goods included in the shopping list information received from the user terminal 200.

Here, the in-vehicle device 100 receives the shopping list information shown in FIG. 3 from the user terminal 200. The shopping list information shown in FIG. 3 includes six items of “T-shirt,” “toilet paper,” “toothbrush,” “headache medicine,” “welsh onion,” and “egg” as purchase goods of the user (user ID:M0001). The shopping list information received from the user terminal 200 is transmitted from the in-vehicle device 100 to the management server 300 together with information on the predetermined area W defined by the current position P and the destination G of the vehicle 10.

In the control server 300, the sale store is extracted based on information on a predetermined area W and shopping lists received from the in-vehicle device 100, as well as store information on individual stores that is stored in the store information DB 330. Here, according to the store information shown in FIG. 4, of the six items included in the shopping list information shown in FIG. 3, “welsh onion” and “egg” are included in the sales goods information on the store A (A store) and the store B (B store), the “toilet paper”, “toothbrush” and “headache medicine” are included in the sales goods information in the store C (C drug), and the “T-shirt” is included in the sales goods information on the store D (D shop). Therefore, in the management server 300, the stores A to D existing in the predetermined area W are extracted as the sales stores. The management server 300 transmits the store information on the stores A to D to the in-vehicle device 100. In the guidance route generation processing, the control unit 110 acquires the store information about each sales store received from the management server 300.

Here, when stores A to D exist as the sales stores in the predetermined area W, five travel routes L1 to L5 shown in FIG. 6 can be generated as the travel routes on which the user able to purchase the purchase goods by dropping in at each sales store located on the travel route of the vehicle 10 while the vehicle 10 is moving toward the destination G. The travel route L1 shown in FIG. 6 is a route that passes through the shortest distance from the current position P to the destination G of the vehicle 10. The store B is located on the travel route L1. According to the store information shown in FIG. 4, in the store B (store B), two items of “welsh onion” and “egg” are sold out of the purchase goods of the user (i.e., the goods included in the shopping list information). Therefore, if the vehicle 10 travels on the travel route L1, the user can purchase two items of “welsh onion” and “egg” out of the purchase goods of the user by dropping in at the store B.

The store C and the store A are located on the travel route L2 shown in FIG. 6. According to the store information shown in FIG. 4, three items of “toilet paper”, “toothbrush” and “headache medicine” out of the purchase goods of the user are sold in the store C (C drug), and two items of “welsh onion” and “egg” out of the purchase goods of the user are sold in the store A (A store). Therefore, if the vehicle 10 travels on the travel route L2, the user can purchase five items of “toilet paper”, “toothbrush”, “headache medicine”, “welsh onion” and “egg” out of the purchase goods of the user by dropping in at the store C and the store A. The store C is located on the travel route L3 shown in FIG. 6. Therefore, if the vehicle 10 travels on the travel route L3, the user can purchase three items of “toilet paper”, “toothbrush” and “headache medicine” out of the purchase goods of the user by dropping in at the store C.

The store D is located on the travel route L4 shown in FIG. 6. According to the store information shown in FIG. 4, one item of “T-shirt” is sold in the store D (D shop) out of the purchase goods of the user. Therefore, if the vehicle 10 travels on the travel route L4, the user can purchase one item of “T-shirt” out of the purchase goods of the user by dropping in at the store D. The store D and the store A are located on the travel route L5 shown in FIG. 6. Therefore, if the vehicle 10 travels on the travel route L5, the user can purchase three items of “T-shirt”, “welsh onion”, and “egg” among the purchase goods of the user by dropping in at the store D and the store A.

As described above, within the predetermined area W, a plurality of travel routes on which the user is able to purchase the purchase goods while the vehicle 10 is moving toward the destination G can be generated. Therefore, in the guidance route generation process according to the present embodiment, a travel route on which the user is able to purchase as many goods as possible included in the shopping list information while the vehicle 10 is moving toward the destination G is generated as a guidance route. In other words, a travel route in which the total number of items of the purchase goods sold at each sales store located on the travel route for moving the vehicle 10 toward the destination G is the largest is generated as the guidance route. Therefore, in the case where it is possible to generate the travel routes L1 to L5 as shown in FIG. 6, the travel route L2 is generated as the guidance route, in the middle of which the user can purchase five items out of the six items of good included in the shopping list information shown in FIG. 3.

In the predetermined area W shown in FIG. 6, as the travel route of the vehicle 10, a travel route passing through the store A or the store B, the store C, and the store D, or a travel route passing through all of the stores A to D may be generated. Then, if the vehicle 10 travels such a travel route, the user can purchase all of the six items of purchase goods included in the shopping list information shown in FIG. 3 during the traveling of the travel route. However, when the vehicle 10 travels such a travel route, the vehicle 10 returns to the route once traveled, or moves in a direction opposite to the destination G. That is, in the case where the vehicle 10 travels such a travel route, the user does not drop in at each sale store while the vehicle 10 is moving toward the destination, and the vehicle 10 moves toward the sales store for the purpose of purchasing the purchase goods. Therefore, in the guidance route generation processing according to the present embodiment, even if the stores A to D exist within the predetermined area W shown in FIG. 6, the travel route that passes through the store A or the store B, the store C, and the store D, or the travel route that passes through all of the stores A to D cannot be generated as the guidance route. Therefore, it is impossible to generate a guidance route that allows the user to purchase all of the six items of purchase goods included in the shopping list information shown in FIG. 3 while the vehicle 10 is moving toward the destination G.

Further, the control unit 110 displays the generated guidance route and store information regarding each sales store located on the guidance route on the display device 140. Therefore, as described above, when the travel route L2 passing through the store C and the store A is generated as the guidance route, the control unit 110 displays the travel route L2 as the guidance route on the display device 140, as shown in FIG. 7. Further, the control unit 110 displays store information relating to each of the store C and the store A located on the travel route L2 on the display device 140.

At this time, as shown in FIG. 7, the store information regarding each sales store displayed on the display device 140 includes price information and coupon information regarding the purchase goods of the user sale at each sales store. That is, the store information related to the store A includes price information on each of “welsh onion” and “egg” which are purchase goods of the user, and coupon information indicating that “egg 10% OFF coupon” is issued. The store information related to the store C includes price information on each of “toilet paper,” “toothbrush,” and “headache medicine,” which are purchase goods of the user, and coupon information indicating that “all products 5% OFF coupon” is issued.

(Processing Flow)

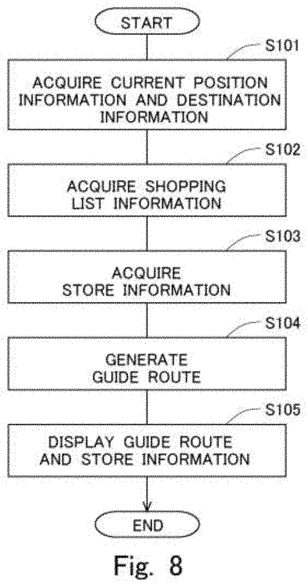

Here, the flow of the guidance route generation processing executed by the control unit 110 will be described with reference to FIG. 8. FIG. 8 is a flowchart illustrating the flow of the guidance route generation processing. In the flow shown in FIG. 8, first, the present position information and the destination information of the vehicle 10 are acquired in the S101. As described above, the current position information of the vehicle 10 is acquired via the position information acquiring unit 150. The destination information of the vehicle 10 is acquired via the input device 130.

Next, in a S102, shopping list information are acquired. As described above, the shopping list information is received from the user terminal 200. Next, in the S103, store information relating to the respective sales stores existing in the predetermined area according to the shopping list information is acquired. As described above, the predetermined area is defined based on the current position and the destination of the vehicle 10. In addition, the store information related to each sales store corresponding to the shopping list information is received from the management server 300.

Next, in the S104, the guidance route is generated based on the present position information and the destination information of the vehicles 10, the shopping list information, and the store information about the respective sales stores. As described above, the guidance route is generated as a travel route on which the user is able to purchase as many goods as possible included in the shopping list information while the vehicle 10 is moving toward the destination.

Next, in the S105, together with the guidance route generated by the S104, the store information regarding the respective sales stores located on the guidance route is displayed on the display device 140.

Since the vehicle 10 travels the guidance route generated by the guidance route generation processing as described above, the user can purchase as many purchase goods as possible while the vehicle 10 is moving toward the destination. In addition, by displaying the store information regarding each sales store located on the guidance route on the display device 140 together with the guidance route, it is possible to prompt the user to go to each sales store while the vehicle 10 is moving toward the destination. That is, it is possible to prompt the user to purchase the purchase goods while the vehicle 10 is moving toward the destination.

Further, as described above, the store information regarding each sales store displayed on the display device 140 includes price information and coupon information regarding the purchase goods sold at each sales store. In this manner, by displaying the price information and the coupon information about the purchase goods on the display device 140, it is possible to further enhance the user's willingness to purchase the purchase goods while traveling toward the destination. However, the display of the price information and the coupon information regarding the purchase goods on the display device 140 is not indispensable. For example, even if the store information displayed on the display device 140 includes only the store name and the goods name of the purchase goods, an effect of prompting the user to go to each sales store while traveling toward the destination may occur.

### Second Embodiment

In the present embodiment, on the shopping list information generated in the user terminal 200, the priority for purchase desires of the user (hereinafter, sometimes referred to as “purchase priority”) is set with respect to each of the goods included in the shopping list information. The purchase priority may be input by the user when the user inputs the purchase goods to the user terminal 200.

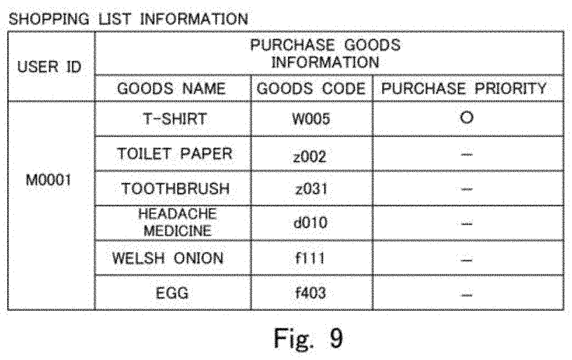

FIG. 9 is a diagram illustrating an exemplary table configuration of shopping list information stored in the shopping list information DB 240 according to the present embodiment. The shopping list information table shown in FIG. 9 has a user ID field and purchase goods information field, similarly to the shopping information table according to the first embodiment shown in FIG. 3. In addition to the good name (item) and the good code of each purchase good, the purchase priority for each purchase good is input to the purchase goods information field. In the case shown in FIG. 9, as in the case of the shopping information table shown in FIG. 3, a total of six items of “T-shirt”, “toilet paper”, “toothbrush”, “headache medicine”, “welsh onion”, and “egg” are registered as purchase goods of the user (user ID:M0001). Furthermore, the mark of “◯” is entered only in the field of purchase priority for “T-shirt” in the purchase goods information field. This indicates that the purchase priority for “T-shirt” is set to the highest among the total six items of purchase goods.

In the shopping support system 1 according to the present embodiment, shopping list information including the purchase priority of each purchase good as shown in FIG. 9 is transmitted from the user terminal 200 to the in-vehicle device 100. Then, in the guidance route generation processing, the control unit 110 of the in-vehicle device 100 generates a guidance route based on the purchase priority of each purchase good included in the shopping list information. More specifically, in the guidance route generation processing according to the present embodiment, a travel route on which the user is able to purchase as many goods as possible included in the shopping list information while the vehicle is moving toward the destination, among travel routes that passes through a sales store at which the sales good having the highest priority is sold among the plurality of sales stores existing in the predetermined area W.

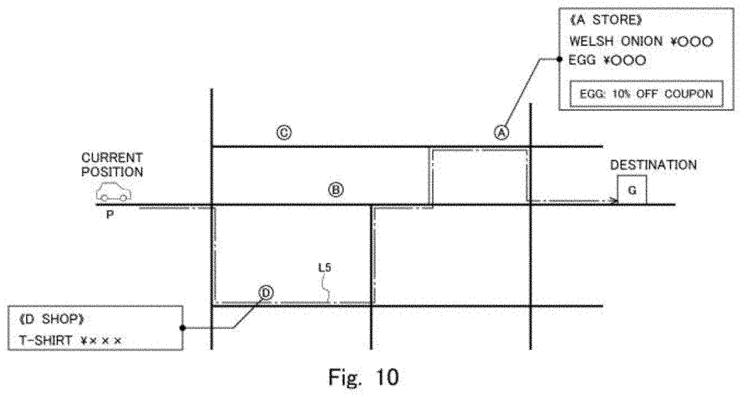

FIG. 10 is a diagram for explaining a guidance route of the vehicle 10 and store information relating to each sales store located on the guidance route, which is displayed on the display device 140 of the in-vehicle device 100 as a result of execution of the guidance route generation process. Here, the processing performed on the assumption that the in-vehicle device 100 has received the shopping list information shown in FIG. 9 will be described as an example. As described above, in the shopping list information shown in FIG. 9, the purchase priority of “T-shirt” is set to the highest among the total six items of purchase goods. Therefore, when the in-vehicle device 100 receives the shopping list information shown in FIG. 9, in the guidance route generation processing, a travel route passing through the store D (D shop) where the “T-shirt” which is the purchase good having the highest purchase priority of the user is sold is generated as the guidance route. At this time, a travel route on which the user is able to purchase as many goods as possible included in the shopping list information while the vehicle is moving toward the destination, among travel routes passing through the store D, is generated as the guidance route.

Here, as shown in FIG. 6, two types of travel routes L4 and L5 can be generated as the travel route passing through the store D. However, only the store D is located on the travel route L4. Therefore, as described above, if the vehicle 10 travels on the travel route L4, only one item of “T-shirt” can be purchased by the user. On the other hand, the store D and the store A are located on the travel route L5. Therefore, as described above, if the vehicle 10 travels on the traveling path L5, the user can purchase three items of “T-shirt”, “welsh onion”, and “egg”. That is, when the vehicle 10 travels on the travel route L5, the user can purchase more purchase goods than when the vehicle 10 travels on the travel route L4.

Therefore, in the guidance route generation processing according to the present embodiment, as shown in FIG. 10, the travel route L5 is generated as the guidance route. Further, in this case, on the display device 140, the travel route L5 is displayed as a guidance route, and store information relating to the store D and the store A located on the travel route L5 is displayed.

Since the vehicle 10 travels the guidance route generated by the guidance route generation processing as described above, the user can purchase as many purchase goods as possible while purchasing the purchase good having the highest purchase priority within a possible range while the vehicle 10 is moving toward the destination.

### Third Embodiment

Also, in the present embodiment, the control unit 110 of the in-vehicle device 100 executes the same guidance route generation processing as in the first embodiment. Then, in the guidance route generation processing, when a plurality of guidance routes of the vehicle 10 can be generated, the control unit 110 displays the generated plurality of guidance routes and store information regarding each sales store located on each guidance route on the display device 140.

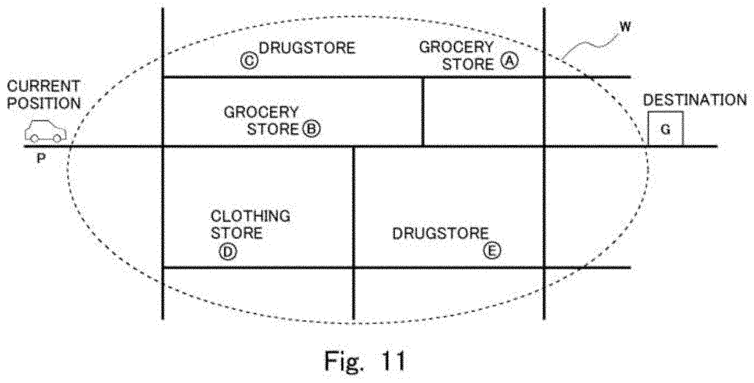

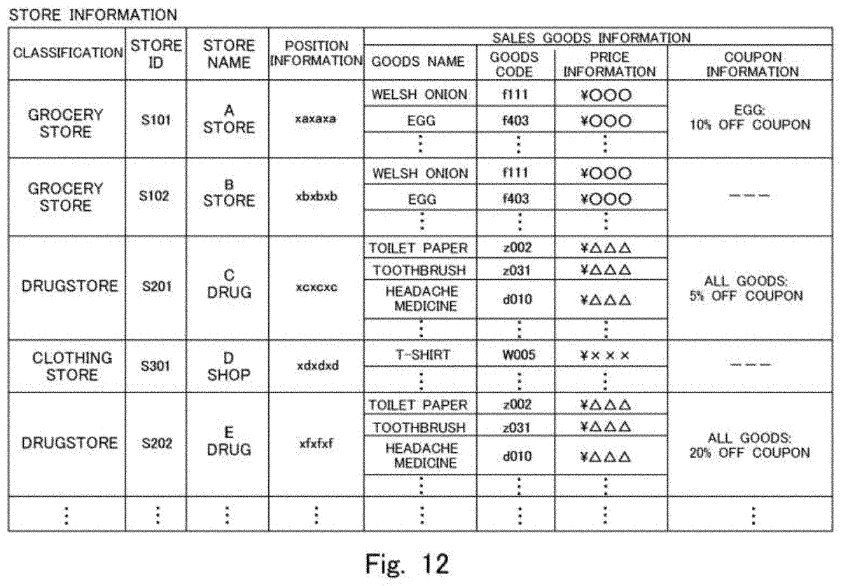

FIG. 11 is a diagram illustrating a predetermined area W in which the guidance route of the vehicle 10 can be generated, and a store existing in the predetermined area W. Here, in the predetermined area W shown in FIG. 11, stores E exist in addition to stores A to D same to FIG. 5. FIG. 12 is a diagram illustrating an exemplary table configuration of store information stored in the store information DB 330 of the managing server 300. The stores A to E shown in FIG. 11 correspond to “A store”, “B store”, “C drag”, “D shop” and “E drag”, respectively, which are included in the store information table shown in FIG. 12. That is, the store information included in the store information table shown in FIG. 12 indicates the store information relating to the stores A to E shown in FIG. 11. The contents of the store information relating to the stores A to D shown in FIG. 12 are the same as those shown in FIG. 4. According to the store information shown in FIG. 12, “toilet paper,” “toothbrush,” and “headache medicine” out of the six items included in the shopping list information shown in FIG. 3 are included in the sales goods information on the store E (E-drug).

Therefore, in the present embodiment, when the management server 300 receives the shopping list information shown in FIG. 3 from the in-vehicle device 100 together with the information on the predetermined area W, the stores A to E existing in the predetermined area W are extracted as the sales stores. The store information on each of the stores A to E is transmitted from the management server 300 to the in-vehicle device 100. In the guidance route generation processing, the control unit 110 acquires the store information on each sales store received from the management server 300.

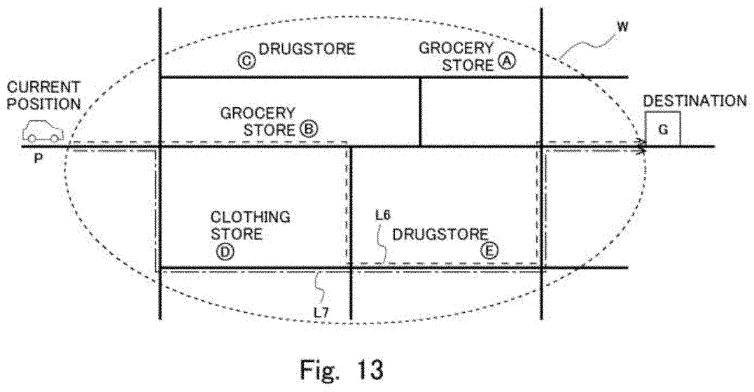

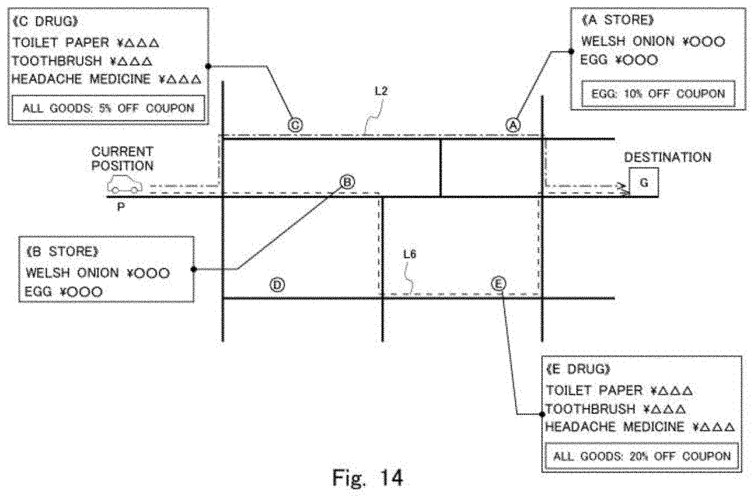

FIG. 13 is a diagram for explaining two types of travel routes of the vehicle 10 that can be generated within the predetermined area W. FIG. 13 shows a travel route other than the travel routes L1 to L5 shown in FIG. 6. FIG. 14 is a diagram for explaining a guidance route of the vehicle 10 and store information relating to each sales store located on the guidance route, which is displayed on the display device 140 of the in-vehicle device 100 as a result of execution of the guidance route generation process.

If a store E is present in addition to the stores A to D as a sales store in the predetermined area W, a travel route that passes through the store E can be generated in addition to the travel routes L1 to L5 shown in FIG. 6 as a travel route that allows the user to purchase the purchase goods by dropping in at each sales store located on the travel route of the vehicle 10 while the vehicle 10 is moving toward the destination G. That is, in addition to the travel routes L1 to L5 shown in FIG. 6, two types of travel routes L6 and L7 shown in FIG. 13 can be generated within the predetermined area W.

Here, the store B and the store E are located on the travel route L6 shown in FIG. 13. According to the store information shown in FIG. 12, in the store B (B store), two items of “welsh onion” and “egg” are sold out of the purchase goods of the user, and in the store E (E drag), three items of “toilet paper”, “toothbrush”, and “headache medicine” are sold out of the purchase goods of the user. Therefore, if the vehicle 10 travels on the travel route L6, the user can purchase five items of the purchase goods of the user, namely “welsh onion”, “egg”, “toilet paper”, “toothbrush” and “headache medicine”, by dropping in at the store B and the store E.

The store D and the store E are located on the travel route L7 shown in FIG. 13. According to the store information shown in FIG. 12, one item of “T-shirt” out of the purchase goods of the user is sold in the store D (D shop). Therefore, if the vehicle 10 travels on the travel route L7, the user can purchase four items of the purchase goods of the user, namely “T-shirt”, “toilet paper”, “toothbrush” and “headache medicine”, by dropping in at the store D and the store E.

In this case, the total number of items of the purchase goods sold in each store located on the travel route on which the vehicle 10 moves toward the destination G is the same number (five items) in the travel route L2 shown in FIG. 6 and the travel route L6 shown in FIG. 13. Therefore, while the vehicle 10 is moving toward the destination G, there are two travel routes, i.e., the travel route L2 and the travel route L6, on which the user is able to purchase as many goods as possible included in the shopping list information while the vehicle is moving toward the destination G.

Therefore, in the guidance route generation processing, the control unit 110 generates the travel route L2 and the travel route L6 as guidance routes. Then, as shown in FIG. 14, the control unit 110 displays the travel route L2 and the travel route L6 on the display device 140 as guide routes. Further, the control unit 110 displays on the display device 140 store information relating to each of the stores C and A located on the travel route L2 and store information relating to each of the stores B and E located on the travel route L6. As a result, two guidance routes and store information regarding each sales store located on each guidance route are provided to the user.

As described above, when a plurality of guidance routes of the vehicle 10 can be generated, by providing the user with the store information regarding each sales store located on each guidance route together with the plurality of guidance routes, the user can select a travel route on which the vehicle 10 is actually traveled based on the information. Further, at this time, if the store information regarding each sales store includes price information and coupon information regarding the purchase goods sold at each sales store, more useful information can be provided to the user as reference information when selecting the travel route on which the vehicle 10 is actually traveled.

### Fourth Embodiment

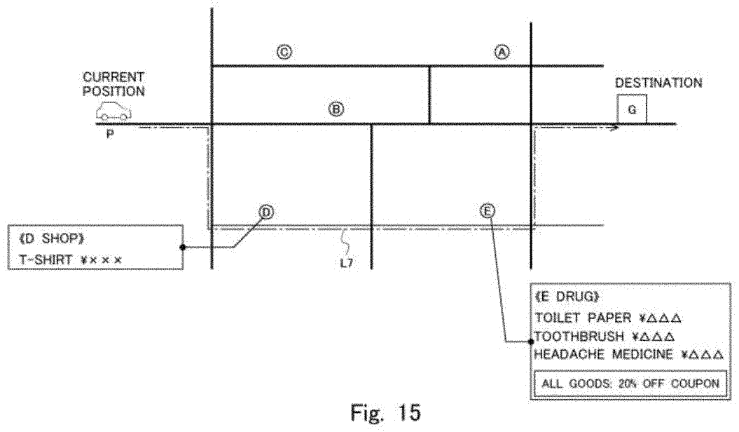

In the present embodiment, similarly to the second embodiment, on the shopping list information generated in the user terminal 200, the purchase priority of the user is set with respect to each of the goods included in the shopping list information. Here, as shown in FIG. 13, a guide route generated by the guide route generation processing will be described in a case where stores A to E exist within a predetermined area W and in a case where the in-vehicle device 100 receives shopping list information in which the purchase priority for “T-shirt” is set to the highest among the total six items of purchase goods as shown in FIG. 9. Here, FIG. 15 is a diagram for explaining a guidance route of the vehicle 10 and store information relating to each sales store located on the guidance route, which is displayed on the display device 140 of the in-vehicle device 100 as a result of execution of the guidance route generation process.

In the guidance route generation processing according to the present embodiment, a travel route passing through the store D (D shop) where the “T-shirt” which is the purchase good having the highest purchase priority of the user is sold is generated as the guidance route. At this time, a travel route on which the user is able to purchase as many goods as possible included in the shopping list information while the vehicle is moving toward the destination, among travel routes passing through the store D, is generated as the guidance route.

Here, when the stores A to E are present in the predetermined area W, as a travel route through the store D, a travel route L5 through the store D and the store A, as shown in FIG. 6, and a travel route L7 through the store D and the store E, as shown in FIG. 13, can be generated. At this time, if the vehicle 10 travels on the travel route L5, the user can purchase three items of “T-shirt”, “welsh onion”, and “egg” out of the purchase goods of the user. On the other hand, if the vehicle 10 travels on the travel route L7, the user can purchase four items of “T-shirt”, “toilet paper”, “toothbrush” and “headache medicine” out of the purchase goods of the user. That is, when the vehicle 10 travels on the travel route L7, the user can purchase more purchase goods than when the vehicle 10 travels on the travel route L5.

That is, a travel route on which the user is able to purchase as many goods as possible included in the shopping list information while the vehicle is moving toward the destination, among travel routes passing through the store D, is the travel route L7. Therefore, in the guidance route generation processing according to the present embodiment, as shown in FIG. 15, the travel route L7 is generated as the guidance route. Further, in this case, on the display device 140, the travel route L7 is displayed as a guidance route, and store information regarding the store D and the store E located on the travel route L7 is displayed.

In each of the above embodiments, the in-vehicle device 100 corresponds to the “information processing device” according to the first embodiment of the present disclosure. However, the “information processing device” according to the first embodiment of the present disclosure does not necessarily have to be an in-vehicle device. For example, a configuration may be employed in which the management server 300 performs the function of the “information processing device” according to the first aspect of the present disclosure, in the shopping support system 1 according to each of the above embodiments. Further, a configuration may be employed in which both the in-vehicle device 100 and the management server 300 perform the function of the “information processing device” according to the first aspect of the present disclosure, in the shopping support system 1 according to each of the above embodiments.

Further, in each of the above-described embodiments, the display device 140 of the in-vehicle device 100 displays the guidance route and the store information regarding to each sales store, thereby providing these pieces of information to the user. However, it is not indispensable to display the guidance route and the store information regarding to each sales store on the display device 140. For example, these pieces of information may be provided as sound to the user in the passenger compartment of the vehicle 10. In addition, only the guidance route may be displayed on the display device 140, and the store information regarding each sales store may be provided to the user by sound.

Further, in each of the embodiments described above, the price information and the coupon information regarding to the purchase goods of the user correspond to “advertisement information about the goods included in the shopping list information” according to the present disclosure. However, the “advertisement information about the goods included in the shopping list information” according to the present disclosure is not limited to these pieces of information, and may be information on other services or the like that may have an effect of increasing the user's willingness to purchase the goods included in the shopping list information.

### Other Embodiments

The above-described embodiments are examples, and the present disclosure can be implemented with changes made as appropriate without departing from the gist of the present disclosure. The processing and units described in the present disclosure can be implemented by being freely combined unless technical conflicts arise.

Moreover, the processing described as processing to be performed by a single apparatus may be performed by a plurality of apparatuses in a shared manner. Alternatively, the processing described as processing to be performed by different apparatuses may be performed by a single apparatus. In a computer system, it can be flexibly changed which hardware component (server component) is used to implement each function.

The present disclosure can also be implemented by providing a computer program designed to implement the functions described in the above embodiments to a computer, and by one or more processors included in the computer reading and executing the program. Such a computer program may be provided to the computer by using a non-transient computer-readable storage medium that can be connected to a system bus of the computer, or may be provided to the computer via a network. Examples of the non-transient computer-readable storage medium include any types of disks/discs such as magnetic disks (floppy(R) disk, hard disk drive (HDD), and the like) and optical discs (CD-ROM, DVD disc, Blu-ray Disc, and the like), read-only memory (ROM), random access memory (RAM), EPROM, EEPROM, magnetic card, flash memory, optical card, and any type of media suitable for storing therein electronic instructions.

What is claimed is:

1. An information processing device for generating a guidance route which is a travel route from a current position of a vehicle in which a user is riding to a destination of the vehicle, and providing the generated guidance route to the user, wherein the information processing device includes a controller comprising at least one processor configured to execute:
acquiring shopping list information, which is information on a list of goods that the user riding in the vehicle desires to purchase,
acquiring store information which is information relating to each of a plurality of sales stores existing in a predetermined area in which the guidance route can be generated and selling at least a part of the goods included in the shopping list information, the store information including information about the goods included in the shopping list information and being sold at each of the sales store,
generating, as the guidance route, on the basis of the shopping list information and the store information relating to each of the plurality of sales stores, a travel route on which the user is able to purchase as many goods as possible included in the shopping list information by dropping in at each of the sales stores located on the travel route of the vehicle while the vehicle is moving toward the destination, and
providing the user with the store information about each of the sale stores located on the guidance route, with the guidance route.

2. The information processing device as set forth in claim 1, wherein
in cases where priority for purchase desires of the user is set with respect to each of the goods included in the shopping list information, the controller generates, as the guidance route, a travel route on which the user is able to purchase as many goods as possible included in the shopping list information while the vehicle is moving toward the destination, among travel routes that passes through a sales store at which the good having the highest priority is sold among the plurality of sales stores.

3. The information processing device as set forth in claim 1, wherein
in cases where it is possible to generate a plurality of guidance routes, the controller provides the user with the plurality of guidance routes generated and the store information regarding each of the sales stores located on each guidance route.

4. The information processing device as set forth in claim 1, wherein the store information regarding each of the sales stores located on the guidance route, which is provided to the user by the controller, includes advertisement information about the goods included in the shopping list information and being sold at each of the sales stores.

5. An information processing method for generating a guidance route which is a travel route from a current position of a vehicle in which a user is riding to a destination of the vehicle, and providing the generated guidance route to the user, by a computer, wherein the information processing method includes;
a step of acquiring shopping list information, which is information on a list of goods that the user riding in the vehicle desires to purchase,
a step of acquiring store information which is information relating to each of a plurality of sales stores existing in a predetermined area in which the guidance route can be generated and selling at least a part of the goods included in the shopping list information, the store information including information about the goods included in the shopping list information and being sold at each of the sales store,
a step of generating, as the guidance route, on the basis of the shopping list information and the store information relating to each of the plurality of sales stores, a travel route on which the user is able to purchase as many goods as possible included in the shopping list information by dropping in at each of the sales stores located on the travel route of the vehicle while the vehicle is moving toward the destination, and
a step of providing the user with the store information about each of the sale stores located on the guidance route, with the guidance route.

6. A non-transitory storage medium storing a program being configured to cause a computer to generate a guidance route which is a travel route from a current position of a vehicle in which a user is riding to a destination of the vehicle, and provide the generated guidance route to the user, wherein the program is configured to cause the computer to execute;
a step of acquiring shopping list information, which is information on a list of goods that the user riding in the vehicle desires to purchase,
a step of acquiring store information which is information relating to each of a plurality of sales stores existing in a predetermined area in which the guidance route can be generated and selling at least a part of the goods included in the shopping list information, the store information including information about the goods included in the shopping list information and being sold at each of the sales store,
a step of generating, as the guidance route, on the basis of the shopping list information and the store information relating to each of the plurality of sales stores, a travel route on which the user is able to purchase as many goods as possible included in the shopping list information by dropping in at each of the sales stores located on the travel route of the vehicle while the vehicle is moving toward the destination, and
a step of providing the user with the store information about each of the sale stores located on the guidance route, with the guidance route.
